(19) United States
(12) Patent Application Publication
(10) Pub. No.: US 2012/0155133 A1
(43) Pub. Date: Jun. 21, 2012

(54) DIRECT CURRENT/ DIRECT CURRENT CONVERTER FOR REDUCING SWITCHING LOSS, WIRELESS POWER RECEIVER INCLUDING DIRECT CURRENT/ DIRECT CURRENT CONVERTER

(76) Inventors: Dong Zo KIM, Yongin-si (KR); Young Tack HONG, Seongnam-si (KR); Young Jin MOON, Gwangju (KR); Sang Wook KWON, Seongnam-si (KR); Yun Kwon PARK, Dongducheon-sio (KR); Chang Sik YOO, Seoul (KR); Eun Seok PARK, Suwon-si (KR); Ki Young KIM, Yongin-si (KR); Young Ho RYU, Yongin-si (KR); Nam Yum KIM, Seoul (KR); Jin Sung CHOI, Gimpo-si (KR); Yong Seong ROH, Incheon (KR)

(21) Appl. No.: 13/329,891

(22) Filed: Dec. 19, 2011

(30) Foreign Application Priority Data
Dec. 20, 2010 (KR) 10-2010-0130861

(51) Int. Cl. H02M 7/04; G05F 1/46

(52) U.S. Cl. 363/84; 323/284

(57) ABSTRACT

Provided are a direct current/direct current (DC/DC) converter and a wireless power receiver including the DC/DC converter. In one embodiment, a direct current-direct current (DC/DC) converter for use in a wireless power receiver, the DC/DC converter may include: a voltage converting unit configured to convert, DC voltage, to a predetermined DC voltage; a turn-on switch configured to control current flow of the DC voltage through the voltage converting unit; and a switching controller configured to: detect an amount of current of the voltage converting unit based on a first turn-on period of the turn-on switch, set a second turn-on period of the turn-on switch based on the detected amount of current, and control the turn-on switch based on the second turn-on period.

### CROSS-REFERENCE TO RELATED APPLICATION(S)

This application claims the benefit under 35 U.S.C. §119(a) of Korean Patent Application No. 10-2010-0130861, filed on Dec. 20, 2010, in the Korean Intellectual Property Office, the entire disclosure of which is incorporated herein by reference for all purposes.

### BACKGROUND

1. Field

The following description relates to a direct current-direct current (DC/DC) converter for use in a wireless power receiver.

2. Description of Related Art

Direct current-direct current (DC/DC) converters are generally used in wireless power transmission systems, portable multimedia devices, and/or the like. They may be configured to receive a DC voltage and then may raise or reduce the voltage to a voltage of a stable level requested by an output unit. In one conventional DC/DC converter, an input unit may provide the output unit with a voltage that is requested by the output unit and thus, an efficiency of the DC/DC converter may approach 100%. The efficiency of DC/DC converter may be reduced for many reasons including a switching loss and a conduction loss.

The switching loss may occur, for instance when a transistor that corresponds to a switch and that is included in the DC/DC converter is turned on, and the conduction loss may occur due to a parasitic resistance of the transistor and a parasitic resistance of an inductor inside the DC/DC converter. While the switching loss may be assumed to be a constant value (regardless of a magnitude of an inputted current), the conduction loss may be proportional to the inputted current. Thus, when a low current is inputted, a component of the switching loss may be higher than a component of the conduction loss, and efficiency may decrease.

### SUMMARY

According to an aspect, a direct current-direct current (DC/DC) converter for use in a wireless power receiver may include: a voltage converting unit configured to convert, DC voltage, to a predetermined DC voltage; a turn-on switch configured to control current flow of the DC voltage through the voltage converting unit; and a switching controller configured to: detect an amount of current of the voltage converting unit based on a first turn-on period of the turn-on switch, set a second turn-on period of the turn-on switch based on the detected amount of current, and control the turn-on switch based on the second turn-on period.

The amount of current of the voltage converting unit may comprise an amount of current inputted to the voltage converting unit or an amount of current outputted from the voltage converting unit.

When the detected amount of current is greater than a predetermined reference value, the switching controller may be configured to set the second turn-on period to be shorter when the detected amount of current is less than or equal to the predetermined reference value.

When the detected amount of current is less than a predetermined reference value, the switching controller may be configured to set the second turn-on period to be longer when the detected amount of current is greater than or equal to the predetermined reference.

The switching controller may include: a voltage divider configured to divide, in a predetermined ratio, a voltage outputted from the voltage converting unit; an error amplifier configured to amplify and output a difference value between an output voltage of the voltage divider and a predetermined reference voltage; a first comparator configured to compare the output of the error amplifier with a ramp signal, to output a pulse width modulator (PWM) signal to be used for switching the turn-on switch; a controller configured to set the second turn-on period based on the PWM signal, and to control the turn-on switch based on the second turn-on period; a current detecting unit configured to detect the amount of current of the voltage converting unit based on the first turn-on period of the turn-on switch, and to generate a frequency control signal that controls a frequency of the ramp signal based on the detected amount of current; and a generator configured to control the frequency of the ramp signal based on the frequency control signal, and to output the ramp signal having a changed frequency to the first comparator.

The current detecting unit may include: an electric charge pump configured to output electric charges during a turn-on time where the turn-on switch is turned on based on a turn-on period; a capacitor configured to be charged with electric charges outputted from the electric charge pump during the turn-on time based on the turn-on period, and to discharge electric charges during a turn-off time based on the turn-on period, to output a current measurement voltage; a second comparator configured to compare a current measurement reference voltage with the current measurement voltage; and a controller configured to output a frequency control signal that increases the frequency of the ramp signal when the comparison of the second comparator indicates that the current measurement voltage is greater than the current measurement reference voltage, and to output a frequency control signal that decreases the frequency of the ramp signal when the comparison of the second comparator indicates that the current measurement voltage is less than the current measurement reference voltage.

The second comparator may include a hysteresis comparator that is configured to compare the current measurement voltage with a high-reference voltage or with a low-reference voltage; and the frequency controller may be configured to output a frequency control signal that increases the frequency of the ramp signal when the current measurement voltage is greater than the high-reference voltage, and to output a frequency control signal that decreases the frequency of the ramp signal when the current measurement voltage is less than the low-reference voltage.

According to an aspect, a wireless power receiver may include: a target resonator configured to receive electromagnetic energy from a source resonator; a rectifier configured to rectify an alternating current (AC) signal received from the target resonator, to generate a direct current (DC) signal; and a DC/DC converter configured to adjust a signal level of the DC signal, to output a rated voltage, the DC/DC converter comprises: a voltage converting unit configured to convert, DC voltage, to a predetermined DC voltage; a turn-on switch configured to control current flow of the DC voltage through the voltage converting unit; and a switching controller configured to: detect an amount of current of the voltage converting unit based on a first turn-on period of the turn-on switch, set a second turn-on period of the turn-on switch based on the detected amount of current, and control the turn-on switch based on the second turn-on period.

According to an aspect, a method for converting direct current to direct current (DC/DC) may include: converting, DC voltage, to a predetermined DC voltage; controlling current flow of the DC voltage via a turn-on switch; detecting an amount of current based on a first turn-on period on the turn-on switch; and setting a second turn-on period of the turn-on switch based on the detected amount of current.

Other features and aspects may be apparent from the following detailed description, the drawings, and the claims.

### BRIEF DESCRIPTION OF THE DRAWINGS

FIG. 1 is a diagram illustrating a wireless power transmission system.

FIG. 2 is a diagram illustrating a direct current-direct current (DC/DC) converter that reduces a switching loss.

FIG. 3 is a diagram illustrating a current detecting unit in a DC/DC converter.

FIG. 4 is a diagram illustrating a main timing of a DC/DC converter.

FIG. 5 is a diagram illustrating a case where a current measurement voltage V_{C} is less than low-reference voltage in a current detecting unit of a DC/DC converter.

FIG. 6 is a diagram illustrating a case where a current measurement voltage V_{C} is greater than a high-reference voltage in a current detecting unit of a DC/DC converter.

FIGS. 7 through 13 are diagrams illustrating a resonator structure.

FIG. 14 is a diagram illustrating one equivalent circuit of a resonator for wireless power transmission of FIG. 7.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses and/or systems described herein. Accordingly, various changes, modifications, and equivalents of the systems, apparatuses and/or methods described herein may be suggested to those of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of well-known functions and constructions may be omitted for increased clarity and conciseness.

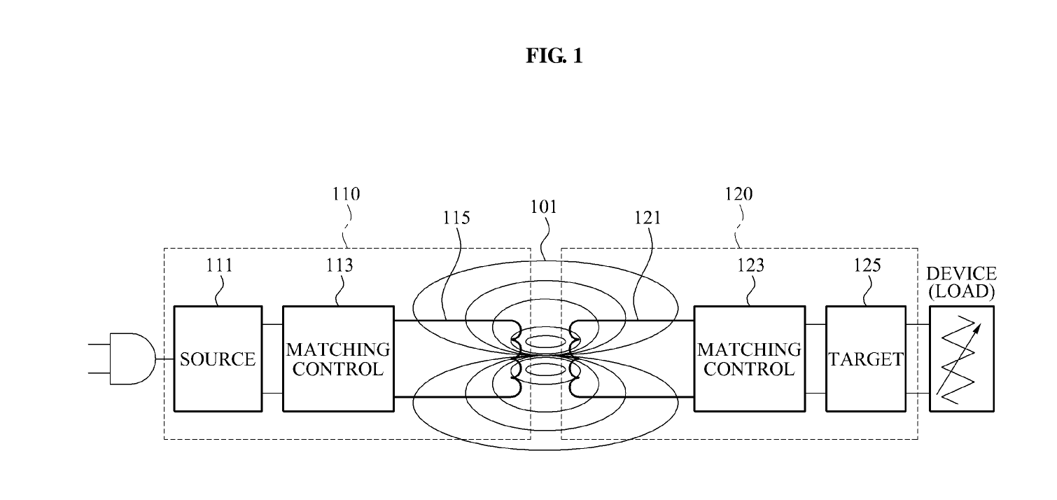

FIG. 1 illustrates a wireless power transmission system. In one or more embodiments, wireless power transmitted may be resonance power.

As shown in FIG. 1, the wireless power transmission system may have a source-target structure including a source and a target. For example, the wireless power transmission system may include a resonance power transmitter 110 corresponding to the source and a resonance power receiver 120 corresponding to the target.

The resonance power transmitter 110 may include a source unit 111 and a source resonator 115. The source unit 111 may be configured to receive energy from an external voltage supplier to generate a resonance power. In some instances, the resonance power transmitter 110 may further include a matching control 113 to perform resonance frequency or impedance matching.

The source unit 111 may include an alternating current (AC)-to-AC (AC/AC) converter, an AC-to-direct current (DC) (AC/DC) converter, and/or a (DC/AC) inverter. The AC/AC converter may be configured to adjust, to a desired level, a signal level of an AC signal input from an external device. And the AC/DC converter may output a DC voltage at a predetermined level by rectifying an AC signal output from the AC/AC converter. The DC/AC inverter may be configured to generate an AC signal (e.g., in a band of a few megahertz (MHz) to tens of MHz) by quickly switching a DC voltage output from the AC/DC converter. Of course, other frequencies of AC power are also possible.

The matching control 113 may be configured to set at least a resonance bandwidth of the source resonator 115, an impedance matching frequency of the source resonator 115, or both. In some implementations, the matching control 113 may include at least one of a source resonance bandwidth setting unit and a source matching frequency setting unit. And the source resonance bandwidth setting unit may set the resonance bandwidth of the source resonator 115. The source matching frequency setting unit may set the impedance matching frequency of the source resonator 115. For example, a Q-factor of the source resonator 115 may be determined based on setting of the resonance bandwidth of the source resonator 115 or setting of the impedance matching frequency of the source resonator 115.

The source resonator 115 may be configured to transfer electromagnetic energy to a target resonator 121. For example, the source resonator 115 may transfer the resonance power to the resonance power receiver 120 through magnetic coupling 101 with the target resonator 121. Accordingly, the source resonator 115 may be configured to resonate within the set resonance bandwidth.

As shown, the resonance power receiver 120 may include the target resonator 121, a matching control 123 to perform resonance frequency or impedance matching, and a target unit 125 to transfer the received resonance power to a device or a load.

The target resonator 121 may be configured to receive the electromagnetic energy from the source resonator 115. The target resonator 121 may be configured to resonate within the set resonance bandwidth.

The matching control 123 may set at least one of a resonance bandwidth of the target resonator 121 and an impedance matching frequency of the target resonator 121. In some implementations, the matching control 123 may include at least one of a target resonance bandwidth setting unit and a target matching frequency setting unit. The target resonance bandwidth setting unit may set the resonance bandwidth of the target resonator 121. The target matching frequency setting unit may be configured to set the impedance matching frequency of the target resonator 121. For example, a Q-factor of the target resonator 121 may be determined based on setting of the resonance bandwidth of the target resonator 121 or setting of the impedance matching frequency of the target resonator 121.

The target unit 125 may be configured to transfer the received resonance power to the load. The target unit 125 may include an AC/DC converter and a DC/DC converter. The AC/DC converter may generate a DC voltage by rectifying an AC signal transmitted from the source resonator 115 to the target resonator 121. And the DC/DC converter may supply a rated voltage to a device or the load by adjusting a voltage level of the DC voltage. For example, the AC/DC converter may be configured as an active rectifier utilizing a delay locked loop.

In one or more embodiments, the source resonator 115 and the target resonator 121 may be configured in a helix coil structured resonator, a spiral coil structured resonator, a meta-structured resonator, or the like.

Referring to FIG. 1, controlling the Q-factor may include setting the resonance bandwidth of the source resonator 115 and the resonance bandwidth of the target resonator 121, and transferring the electromagnetic energy from the source resonator 115 to the target resonator 121 through magnetic coupling 101 between the source resonator 115 and the target resonator 121. The resonance bandwidth of the source resonator 115 may be set to be wider or narrower than the resonance bandwidth of the target resonator 121 in some instances. For example, an unbalanced relationship between a BW-factor of the source resonator 115 and a BW-factor of the target resonator 121 may be maintained by setting the resonance bandwidth of the source resonator 115 to be wider or narrower than the resonance bandwidth of the target resonator 121.

For a wireless power transmission employing a resonance scheme, the resonance bandwidth may be an important factor. When the Q-factor (e.g., considering all of a change in a distance between the source resonator 115 and the target resonator 121, a change in the resonance impedance, impedance mismatching, a reflected signal, and/or the like) is Qt, Qt may have an inverse-proportional relationship with the resonance bandwidth, as given by Equation 1.

$$\begin{matrix}\frac{Δ f}{{f}_{0}} = \frac{1}{Qt} \\ = {Γ}_{S , D} + \frac{1}{{BW}_{S}} + \frac{1}{{BW}_{D}}\end{matrix} \qquad [ Equation 1 ]$$

In Equation 1, f₀ denotes a central frequency, Δf denotes a change in a bandwidth, Γ_{S,D} denotes a reflection loss between the source resonator 115 and the target resonator 121, BW_{S} denotes the resonance bandwidth of the source resonator 115, and BW_{D} denotes the resonance bandwidth of the target resonator 121. In Equation 1, the BW-factor may indicate either 1/BW_{S} or 1/BW_{D}.

Due to an external effect, for example, a change in the distance between the source resonator 115 and the target resonator 121, a change in a location of at least one of the source resonator 115 and the target resonator 121, and/or the like, impedance mismatching between the source resonator 115 and the target resonator 121 may occur. The impedance mismatching may be a direct cause in decreasing an efficiency of power transfer. When a reflected wave corresponding to a transmission signal that is partially reflected and returned is detected, the matching control 113 may be configured to determine the impedance mismatching has occurred, and may perform impedance matching. The matching control 113 may change a resonance frequency by detecting a resonance point through a waveform analysis of the reflected wave. The matching control 113 may determine, as the resonance frequency, a frequency having a minimum amplitude in the waveform of the reflected wave.

The source resonator 115 and/or the target resonator 121 in FIG. 1 may have a resonator structure illustrated in FIGS. 7 through 14.

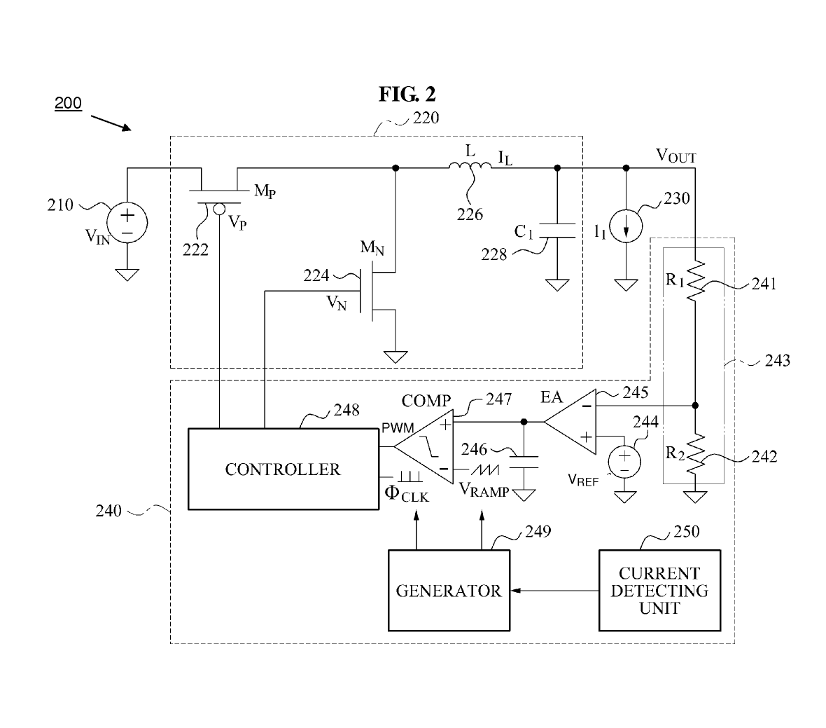

FIG. 2 illustrates a DC/DC converter 200 that reduces a switching loss.

As shown, the DC/DC converter 200 may include a voltage converting unit 220 that converts a voltage of a DC signal V_{IN} received from a voltage source 210 to a predetermined DC voltage V_{OUT}. The predetermined DC voltage V_{OUT} may be provided to a load 230. The DC/DC converter 200 may also include a switching controller 240 that controls the voltage converting unit 220. This may include turning on and off the voltage converting unit 220 is some embodiments.

The voltage converting unit 220 may be configured to convert the voltage of the DC signal provided when a current flows through a turn-on switch 222, to the predetermined DC voltage V_{OUT}. The voltage converting unit 220 may include the turn-on switch 222, a second switch 224, an inductor 226, and a capacitor 228.

For example, in one embodiment, the turn-on switch 222 may be a switch configured to be turned on based on a switching signal V_{P} of the switching controller 240 so as to enable the DC current received from the voltage source 210 to flow through the turn-on switch 222, to provide the DC current I_{L} to the inductor 226.

The second switch 224 may be a switch that operates in reverse to the turn-on switch 222, and may be turned on when the turn-on switch 222 is turned off, based on a switching signal V_{N} of the switching controller 240. When the second switch 224 is turned on, the second switch may be grounded to an input of the inductor 226, for instance.

When the turn-on switch 222 is turned on, the inductor 226 and the capacitor 228 may receive the DC current via the turn-on switch 222, may be charged with the received DC current, and may output a DC of the predetermined voltage V_{OUT}.

In one or more embodiments, the turn-on switch 22 may include a p-channel metal-oxide semiconductor (PMOS) transistor M_{P}, and, the second switch 224 may include a similar transistor M_{N}. Of course, it will be appreciated that other switches or switch elements may be used for the turn-off 222 switch and/or the second switch 224. For example, the switches or switch elements of the switching device may include various electromechanical switches (e.g., contact, toggle, knife, tilt, or the like) or electrical switches (e.g., solenoid, relays, or solid-state elements such as a transistor switch, silicon-controlled rectifier or a triac). Of course, other types of switches are also possible. In various embodiments, the switch may be configured to activate. For example, the switches may select between ON and OFF positions, which permit and prevent the flow of electricity (power), respectively. Accordingly, the switches control may control electrical connection.

The switching controller 240 may detect an amount of current of the voltage converting unit 220 based on a first turn-on period indicating a turn-on period of the turn-on switch 222 at a current point in time. The switching controller 240 may set a second turn-on period indicating a turn-on period that is to be applied to the turn-on switch 222 based on the detected amount of current, and may control the turn-on switch 222 based on the second turn-on period. For example, the amount of current of the voltage converting unit 220 may be an amount of current inputted to the voltage converting unit 220 or an amount of current outputted from the voltage converting unit 220.

When the amount of current of the voltage converting unit 220 is greater than a predetermined reference value, the switching controller 240 may be configured to set the second turn-on period to be shorter when the amount of current of the voltage converting unit 220 is less than or equal to the predetermined reference value.

When the amount of current of the voltage converting unit 220 is less than a predetermined reference value, the switching controller 240 may set the second turn-on period to be longer when the amount of current of the voltage converting unit 220 is greater than or equal to the predetermined reference value.

The switching controller 240 may include a voltage divider 243, a reference voltage source 244, an error amplifier 245, a capacitor 246, a comparator 247, a controller 248, a generator 249, and a current detecting unit 250.

The voltage divider 243 may be configured to divide a voltage outputted from the voltage converting unit 220. For example, the voltage may be divided in a predetermined ratio using two resistors 241 (R₁) and 242 (R₂), and may output the divided voltage to the error amplifier 245.

The error amplifier (EA) 245 may be configured to amplify and output a difference value between the output voltage of the voltage divider 243 and a predetermined reference voltage V_{REF} outputted from the reference voltage source 244.

The capacitor 246 may be charged with the output voltage of the error amplifier 245, and may remove noise.

The comparator (COMP) 247 may compare the output of the error amplifier 245 that passes through the capacitor 246 with a ramp signal V_{RAMP} outputted from the generator 249, and may output a pulse width modulator (PWM) signal to be used for switching the turn-on switch 222.

The controller 248 may be configured to set the second turn-on period to be applied to the turn-on switch 222, based on the PWM signal outputted from the comparator 247, and may control the turn-on switch 222 based on the second turn-on period.

The current detecting unit 250 may be configured to detect an amount of current of the voltage converting unit 220 based on the first turn-on period of the turn-on switch 222, and may generate a frequency control signal that can be used to control a frequency of the ramp signal V_{RAMP} based on the detected amount of current of the voltage converting unit 220.

The generator 249 may be configured to control the frequency of the ramp signal V_{RAMP} based on the frequency control signal received from the current detecting unit 250, and may output the ramp signal V_{RAMP} having the changed frequency to the comparator 247. In addition, the generator 249 may be configured to output a clock timing signal Φ_{CLK} to the controller 248 based on the frequency control signal received from the current detecting unit 250.

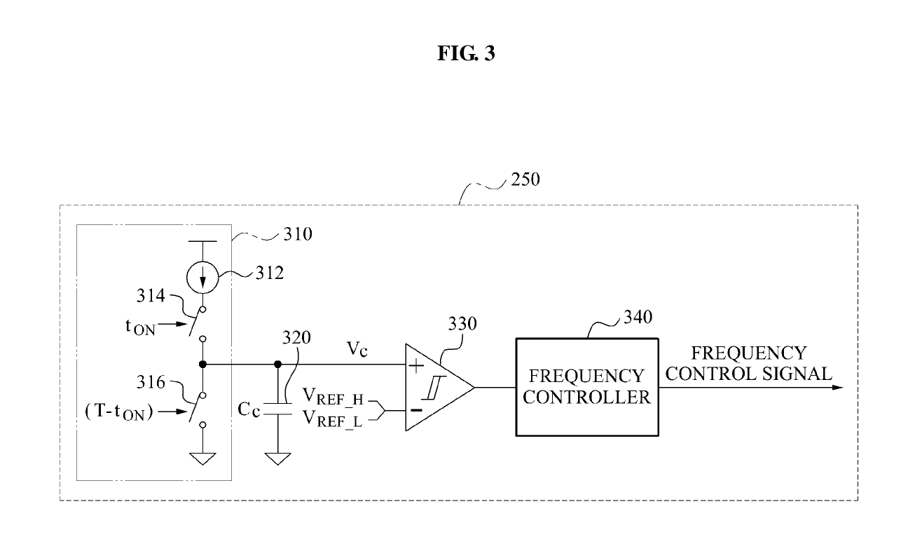

FIG. 3 illustrates a current detecting unit in a DC/DC converter. Referring to FIG. 3, one embodiment of the current detecting unit 250 of FIG. 2 may include an electric charge pump 310, a capacitor 320, a comparator 330, and a frequency controller 340.

The electric charge pump 310 may be configured to output electric charges during a turn-on time t_{ON} where the turn-on switch 222 is turned on based on a turn-on period T. For example, the electric charge pump 310 may be configured to include a current source 312, a first switch 314, and a second switch 316.

The current source 312 may output a predetermined amount of electric charge. For example, the first switch 314 may output electric charges during the turn-on time t_{ON} where the turn-on switch 222 is turned on based on the turn-on period. And the second switch 316 may be grounded and may operate in reverse to the first switch 314.

The capacitor 320 may be charged with the electric charges outputted from the electric charge pump 310 based on the turn-on period of the turn-on switch 222, and may discharge electric charges during a turn-off time based on the turn-on period, to output a current measurement voltage to be used for measuring an amount of current.

The comparator 330 may be configured to compare a current measurement reference voltage (e.g., V_{REF}_{_{—}}_{H} or V_{REF}_{_{—}}_{L} as discussed below) with the current measurement voltage outputted from the capacitor 320, and may transmit a result of the comparison to the frequency controller 340.

The frequency controller 340 may be configured to output a frequency control signal that increases a frequency of a ramp signal when the current measurement voltage is greater than a current measurement reference voltage, and may output a frequency control signal that decreases the frequency of the ramp signal when the current measurement voltage is less than the current measurement reference voltage.

For example, the frequency controller 340 may output the frequency control signal by classifying the frequency of the ramp signal as a reference frequency, ½ reference frequency, ¼ reference frequency, and ⅛ reference frequency.

Even though the frequency of the ramp signal may be changed to be higher, the period of the PWM signal outputted from the comparator 247 of FIG. 1 may become shorter and the period of the turn-on signal outputted from the controller 248 may become shorter. Thus, the turn-on switch 222 may be more frequently turned on and turned off.

For example, when the frequency of the ramp signal may be changed to be lower, the period of the PWM signal outputted from the comparator 247 of FIG. 1 may become long and the period of the turn-on signal outputted from the controller 248 may become longer. Accordingly, in this case, the turn-on switch 222 may be less frequently turned on and turned off.

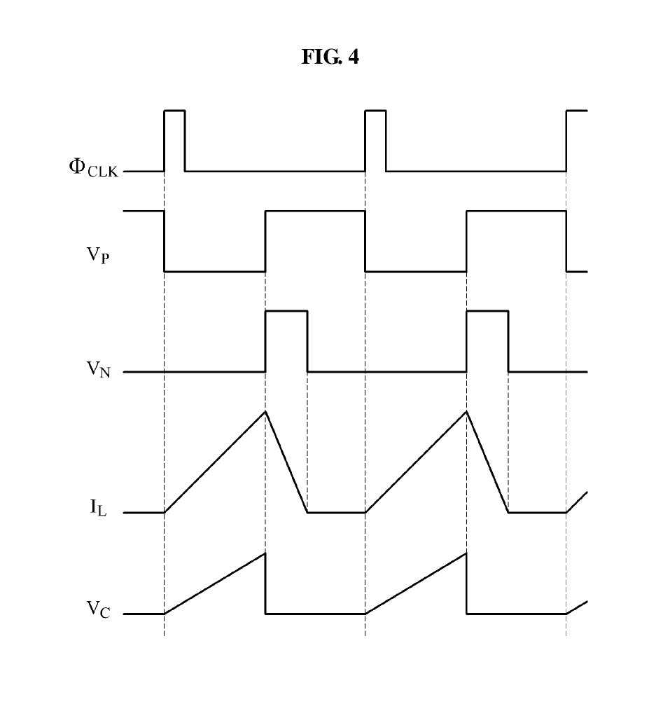

FIG. 4 illustrates a main timing of a DC/DC converter. In particular, FIG. 4 shows waveforms for the clock timing signal Φ_{CLK} the switching signal V_{P} input to the turn-on switch 222, the switching signal V_{N} input to the second switch 224, the current I_{L} of the inductor 226, and a current measurement voltage V_{C} that is outputted from the capacitor 320 of the current detecting unit 250 over corresponding times periods.

As will be appreciated, the current measurement voltage V_{C} may be similar to a waveform of a current I_{L} outputted from the inductor 226.

Accordingly, the current detecting unit 250 may be configured to estimate a magnitude of a peak of the current I_{L} of the inductor 226 without (directly) sensing the current I_{L} of the inductor 226, for instance.

In one or more embodiment, as the amount of current of the voltage converting unit 220 decreases, a turn-on time of the turn-on switch 222 decreases and thus, the peak of the current I_{L} of the inductor 226 and a peak of the current measurement voltage V_{C} may decrease.

The comparator 330 may be configured to compare the current measurement voltage V_{C} with two reference voltages: a high-reference voltage (VREF_H) or a low-reference voltage (VREF_L). For example, the comparator 330 may be a hysteresis comparator.

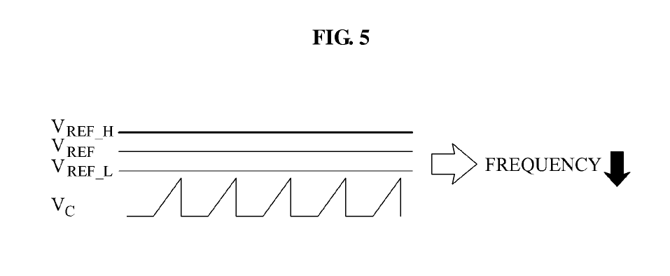

When the current measurement voltage V_{C} is less than VREF_L, the frequency controller 340 may determine that the amount of current is insufficient for a current frequency. FIG. 5 illustrates when a current measurement voltage V_{C} is less than VREF_L in a current detecting unit of a DC/DC converter.

When the current measurement voltage V_{C} is less than VREF_L, the frequency controller 340 may output a frequency control signal that decreases a frequency of a ramp signal.

On the other hand, when the current measurement voltage V_{C} is greater than VREF_H, the frequency controller 340 may determine that the amount of current is excessive for a current frequency.

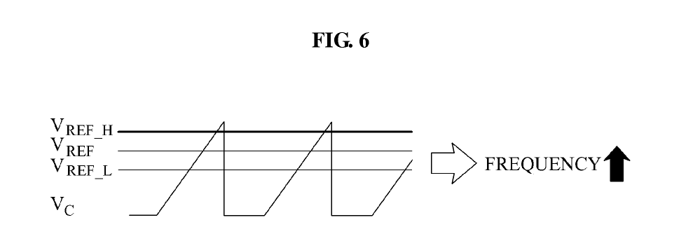

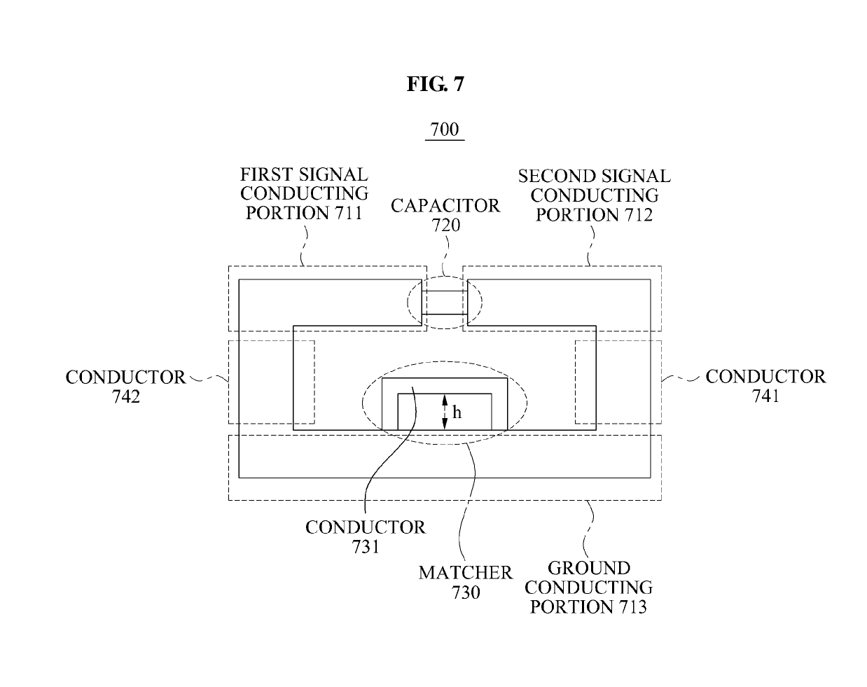

FIG. 6 illustrates a case where a current measurement voltage V_{C} is greater than VREF_H in a current detecting unit of a DC/DC converter. When the current measurement voltage V_{C} is greater than the VREF_H, the frequency controller 340 may output a frequency control signal that increases a frequency of a ramp signal.

Referring again to FIG. 1, the source resonator and/or the target resonator of the wireless power transmission system may be configured as a helix coil structured resonator, a spiral coil structured resonator, a meta-structured resonator, or the like.

One or more of the materials of the embodiment disclosed herein may be metamaterials.

An electromagnetic characteristic of many materials found in nature is that they have a unique magnetic permeability or a unique permittivity. Most materials typically have a positive magnetic permeability or a positive permittivity. Thus, for these materials, a right hand rule may be applied to an electric field, a magnetic field, and a pointing vector and thus, the corresponding materials may be referred to as right handed materials (RHMs).

On the other hand, a material having a magnetic permeability or a permittivity which is not ordinarily found in nature or is artificially-designed (or man-made) may be referred to herein as a “metamaterial.” Metamaterials may be classified into an epsilon negative (ENG) material, a mu negative (MNG) material, a double negative (DNG) material, a negative refractive index (NRI) material, a left-handed (LH) material, and the like, based on a sign of the corresponding permittivity or magnetic permeability.

The magnetic permeability may indicate a ratio between a magnetic flux density occurring with respect to a given magnetic field in a corresponding material and a magnetic flux density occurring with respect to the given magnetic field in a vacuum state. The permittivity indicates a ratio between an electric flux density, occurring with respect to a given electric field in a corresponding material, and an electric flux density, occurring with respect to the given electric field, in a vacuum state. The magnetic permeability and the permittivity, in some embodiments, may be used to determine a propagation constant of a corresponding material in a given frequency or a given wavelength. An electromagnetic characteristic of the corresponding material may be determined based on the magnetic permeability and the permittivity. According to an aspect, the metamaterial may be easily disposed in a resonance state without significant material size changes. This may be practical for a relatively large wavelength area or a relatively low frequency area, for instance.

FIG. 7 illustrates a resonator 700 having a two-dimensional (2D) structure.

As shown, the resonator 700 having the 2D structure may include a transmission line, a capacitor 720, a matcher 730, and conductors 741 and 742. The transmission line may include, for instance, a first signal conducting portion 711, a second signal conducting portion 712, and a ground conducting portion 713.

The capacitor 720 may be inserted or otherwise positioned in series between the first signal conducting portion 711 and the second signal conducting portion 712 so that an electric field may be confined within the capacitor 720. In various implementations, the transmission line may include at least one conductor in an upper portion of the transmission line, and may also include at least one conductor in a lower portion of the transmission line. A current may flow through the at least one conductor disposed in the upper portion of the transmission line and the at least one conductor disposed in the lower portion of the transmission may be electrically grounded. As shown in FIG. 7, the resonator 700 may be configured to have a generally 2D structure. The transmission line may include the first signal conducting portion 711 and the second signal conducting portion 712 in the upper portion of the transmission line, and may include the ground conducting portion 713 in the lower portion of the transmission line. As shown, the first signal conducting portion 711 and the second signal conducting portion 712 may be disposed to face the ground conducting portion 713 with current flowing through the first signal conducting portion 711 and the second signal conducting portion 712.

In some implementations, one end of the first signal conducting portion 711 may be electrically connected (i.e., shorted) to a conductor 742, and another end of the first signal conducting portion 711 may be connected to the capacitor 720. And one end of the second signal conducting portion 712 may be grounded to the conductor 741, and another end of the second signal conducting portion 712 may be connected to the capacitor 720. Accordingly, the first signal conducting portion 711, the second signal conducting portion 712, the ground conducting portion 713, and the conductors 741 and 742 may be connected to each other, such that the resonator 700 may have an electrically “closed-loop structure.” The term “closed-loop structure” as used herein, may include a polygonal structure, for example, a circular structure, a rectangular structure, or the like that is electrically closed. The capacitor 720 may be inserted into an intermediate portion of the transmission line. For example, the capacitor 720 may be inserted into a space between the first signal conducting portion 711 and the second signal conducting portion 712. The capacitor 720 may be configured, in some instances, as a lumped element, a distributed element, or the like. In one implementation, a distributed capacitor may be configured as a distributed element and may include zigzagged conductor lines and a dielectric material having a relatively high permittivity between the zigzagged conductor lines.

When the capacitor 720 is inserted into the transmission line, the resonator 700 may have a property of a metamaterial, as discussed above. For example, the resonator 700 may have a negative magnetic permeability due to the capacitance of the capacitor 720. If so, the resonator 700 may be referred to as a mu negative (MNG) resonator. Various criteria may be applied to determine the capacitance of the capacitor 720. For example, the various criteria for enabling the resonator 700 to have the characteristic of the metamaterial may include one or more of the following: a criterion for enabling the resonator 700 to have a negative magnetic permeability in a target frequency, a criterion for enabling the resonator 700 to have a zeroth order resonance characteristic in the target frequency, or the like.

The resonator 700, also referred to as the MNG resonator 700, may also have a zeroth order resonance characteristic (i.e., having, as a resonance frequency, a frequency when a propagation constant is “0”). If the resonator 700 has the zeroth order resonance characteristic, the resonance frequency may be independent with respect to a physical size of the MNG resonator 700. Moreover, by appropriately designing the capacitor 720, the MNG resonator 700 may sufficiently change the resonance frequency without substantially changing the physical size of the MNG resonator 700 may not be changed.

In a near field, for instance, the electric field may be concentrated on the capacitor 720 inserted into the transmission line. Accordingly, due to the capacitor 720, the magnetic field may become dominant in the near field. In one or more embodiments, the MNG resonator 700 may have a relatively high Q-factor using the capacitor 720 of the lumped element. Thus, it may be possible to enhance power transmission efficiency. For example, the Q-factor indicates a level of an ohmic loss or a ratio of a reactance with respect to a resistance in the wireless power transmission. The efficiency of the wireless power transmission may increase according to an increase in the Q-factor.

The MNG resonator 700 may include a matcher 730 for impedance-matching. For example, the matcher 730 may be configured to appropriately determine and adjust the strength of a magnetic field of the MNG resonator 700, for instance. Depending on the configuration, current may flow in the MNG resonator 700 via a connector, or may flow out from the MNG resonator 700 via the connector. The connector may be connected to the ground conducting portion 713 or the matcher 730. In some instances, power may be transferred through coupling without using a physical connection between the connector and the ground conducting portion 713 or the matcher 730.

As shown in FIG. 7, the matcher 730 may be positioned within the loop formed by the loop structure of the resonator 700. The matcher 730 may adjust the impedance of the resonator 700 by changing the physical shape of the matcher 730. For example, the matcher 730 may include the conductor 731 for the impedance-matching positioned in a location that is separate from the ground conducting portion 713 by a distance h. Accordingly, the impedance of the resonator 700 may be changed by adjusting the distance h. In some instances, a controller may be provided to control the matcher 730 which generates and transmits a control signal to the matcher 730 directing the matcher to change its physical shape so that the impedance of the resonator may be adjusted. For example, the distance h between a conductor 731 of the matcher 730 and the ground conducting portion 713 may be increased or decreased based on the control signal. The controller may generate the control signal based on various factors.

As shown in FIG. 7, the matcher 730 may be configured as a passive element such as the conductor 731, for example. Of course, in other embodiments, the matcher 730 may be configured as an active element such as a diode, a transistor, or the like. If the active element is included in the matcher 730, the active element may be driven based on the control signal generated by the controller, and the impedance of the resonator 700 may be adjusted based on the control signal. For example, when the active element is a diode included in the matcher 730 the impedance of the resonator 700 may be adjusted depending on whether the diode is in an ON state or in an OFF state.

In some instances, a magnetic core may be further provided to pass through the MNG resonator 700. The magnetic core may perform a function of increasing a power transmission distance.

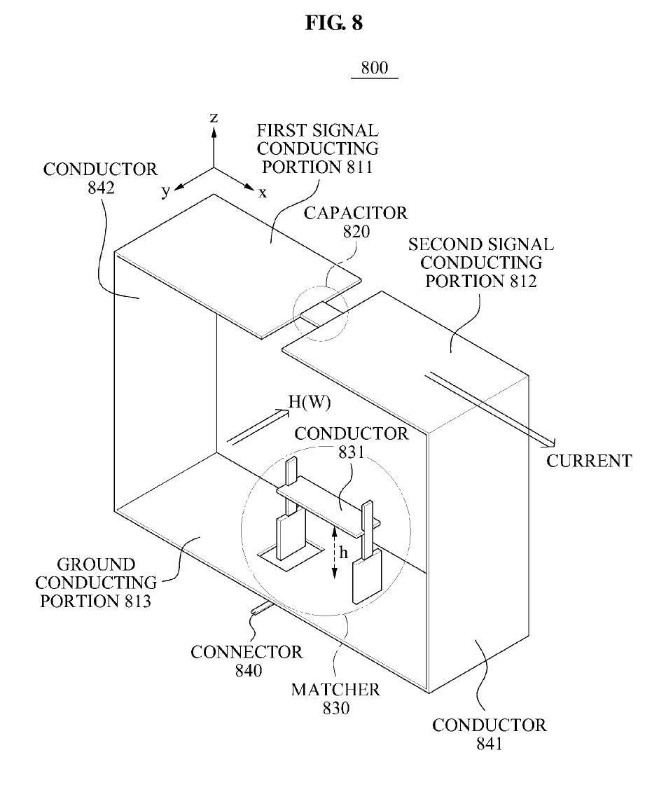

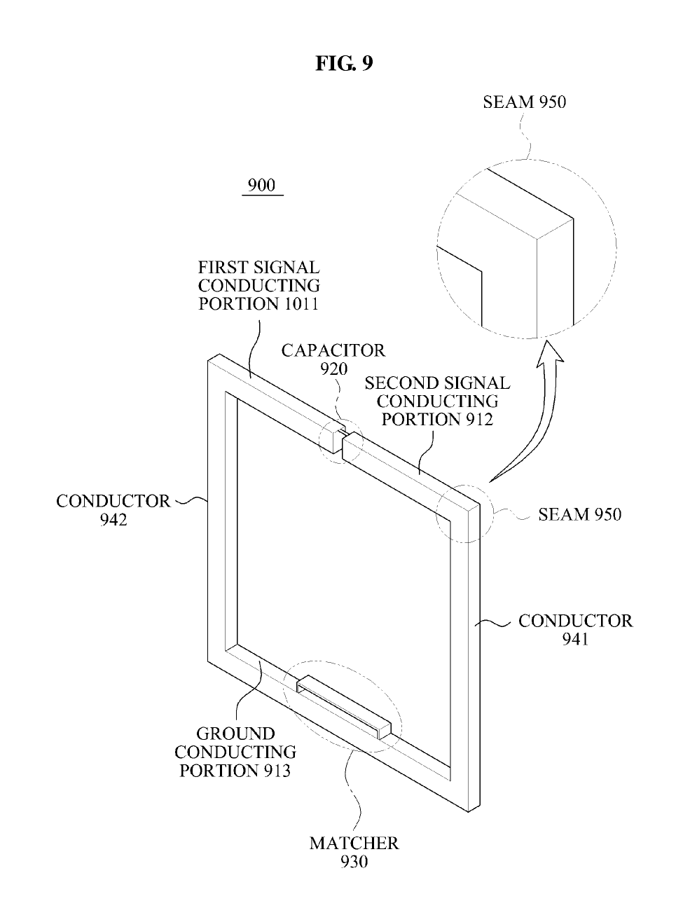

FIG. 8 illustrates a resonator 800 having a three-dimensional (3D) structure.

Referring to FIG. 8, the resonator 800 having the 3D structure may include a transmission line and a capacitor 820. The transmission line may include a first signal conducting portion 811, a second signal conducting portion 812, and a ground conducting portion 813. The capacitor 820 may be inserted, for instance, in series between the first signal conducting portion 811 and the second signal conducting portion 812 of the transmission link such that an electric field may be confined within the capacitor 820.

As shown in FIG. 8, the resonator 800 may have a generally 3D structure. The transmission line may include the first signal conducting portion 811 and the second signal conducting portion 812 in an upper portion of the resonator 800, and may include the ground conducting portion 813 in a lower portion of the resonator 800. The first signal conducting portion 811 and the second signal conducting portion 812 may be disposed to face the ground conducting portion 813. In this arrangement, current may flow in an x direction through the first signal conducting portion 811 and the second signal conducting portion 812. Due to the current, a magnetic field H(W) may be formed in a −y direction. However, it will be appreciated that, the magnetic field H(W) might also be formed in the opposite direction (e.g., a +y direction) in other implementations.

In one or more embodiments, one end of the first signal conducting portion 811 may be electrically connected (i.e., shorted) to a conductor 842, and another end of the first signal conducting portion 811 may be connected to the capacitor 820. One end of the second signal conducting portion 812 may be grounded to the conductor 841, and another end of the second signal conducting portion 812 may be connected to the capacitor 820. Accordingly, the first signal conducting portion 811, the second signal conducting portion 812, the ground conducting portion 813, and the conductors 841 and 842 may be connected to each other, whereby the resonator 800 may have an electrically closed-loop structure. As shown in FIG. 8, the capacitor 820 may be inserted or otherwise positioned between the first signal conducting portion 811 and the second signal conducting portion 812. For example, the capacitor 820 may be inserted into a space between the first signal conducting portion 811 and the second signal conducting portion 812. The capacitor 820 may include, for example, a lumped element, a distributed element, or the like. In one implementation, a distributed capacitor having the shape of the distributed element may include zigzagged conductor lines and a dielectric material having a relatively high permittivity positioned between the zigzagged conductor lines.

When the capacitor 820 is inserted into the transmission line, the resonator 800 may have a property of a metamaterial, in some instances, as discussed above.

For example, when a capacitance of the capacitor inserted is a lumped element, the resonator 800 may have the characteristic of the metamaterial. When the resonator 800 has a negative magnetic permeability by appropriately adjusting the capacitance of the capacitor 820, the resonator 800 may also be referred to as an MNG resonator. Various criteria may be applied to determine the capacitance of the capacitor 820. For example, the various criteria may include, for instance, one or more of the following: a criterion for enabling the resonator 800 to have the characteristic of the metamaterial, a criterion for enabling the resonator 800 to have a negative magnetic permeability in a target frequency, a criterion enabling the resonator 800 to have a zeroth order resonance characteristic in the target frequency, or the like. Based on at least one criterion among the aforementioned criteria, the capacitance of the capacitor 820 may be determined.

The resonator 800, also referred to as the MNG resonator 800, may have a zeroth order resonance characteristic (i.e., having, as a resonance frequency, a frequency when a propagation constant is “0”). If the resonator 800 has a zeroth order resonance characteristic, the resonance frequency may be independent with respect to a physical size of the MNG resonator 800. Thus, by appropriately designing the capacitor 820, the MNG resonator 800 may sufficiently change the resonance frequency without substantially changing the physical size of the MNG resonator 800.

Referring to the MNG resonator 800 of FIG. 8, in a near field, the electric field may be concentrated on the capacitor 820 inserted into the transmission line. Accordingly, due to the capacitor 820, the magnetic field may become dominant in the near field. And, since the MNG resonator 800 having the zeroth-order resonance characteristic may have characteristics similar to a magnetic dipole, the magnetic field may become dominant in the near field. A relatively small amount of the electric field formed due to the insertion of the capacitor 820 may be concentrated on the capacitor 820 and thus, the magnetic field may become further dominant.

Also, the MNG resonator 800 may include a matcher 830 for impedance-matching. The matcher 830 may be configured to appropriately adjust the strength of magnetic field of the MNG resonator 800. The impedance of the MNG resonator 800 may be determined by the matcher 830. In one or more embodiments, current may flow in the MNG resonator 800 via a connector 840, or may flow out from the MNG resonator 800 via the connector 840. And the connector 840 may be connected to the ground conducting portion 813 or the matcher 830.

As shown in FIG. 8, the matcher 830 may be positioned within the loop formed by the loop structure of the resonator 800. The matcher 830 may be configured to adjust the impedance of the resonator 800 by changing the physical shape of the matcher 830. For example, the matcher 830 may include the conductor 831 for the impedance-matching in a location separate from the ground conducting portion 813 by a distance h. The impedance of the resonator 800 may be changed by adjusting the distance h.

In some implementations, a controller may be provided to control the matcher 830. In this case, the matcher 830 may change the physical shape of the matcher 830 based on a control signal generated by the controller. For example, the distance h between the conductor 831 of the matcher 830 and the ground conducting portion 813 may be increased or decreased based on the control signal. Accordingly, the physical shape of the matcher 830 may be changed such that the impedance of the resonator 800 may be adjusted. The distance h between the conductor 831 of the matcher 830 and the ground conducting portion 813 may be adjusted using a variety of schemes. For example, a plurality of conductors may be included in the matcher 830 and the distance h may be adjusted by adaptively activating one of the conductors. Alternatively or additionally, the distance h may be adjusted by adjusting the physical location of the conductor 831 up and down. For instance, the distance h may be controlled based on the control signal of the controller. The controller may generate the control signal using various factors. As shown in FIG. 8, the matcher 830 may be configured as a passive element such as the conductor 831, for instance. Of course, in other embodiments, the matcher 830 may be configured as an active element such as, for example, a diode, a transistor, or the like. When the active element is included in the matcher 830, the active element may be driven based on the control signal generated by the controller, and the impedance of the resonator 800 may be adjusted based on the control signal. For example, if the active element is a diode included in the matcher 830, the impedance of the resonator 800 may be adjusted depending on whether the diode is in an ON state or in an OFF state.

In some implementations, a magnetic core may be further provided to pass through the resonator 800 configured as the MNG resonator. The magnetic core may perform a function of increasing a power transmission distance.

FIG. 9 illustrates a resonator 900 for a wireless power transmission configured as a bulky type.

As used herein, the term “bulky type” may refer to a seamless connection connecting at least two parts in an integrated form.

Referring to FIG. 9, a first signal conducting portion 911 and a conductor 942 may be integrally formed instead of being separately manufactured and thereby be connected to each other. Similarly, the second signal conducting portion 912 and a conductor 941 may also be integrally manufactured.

When the second signal conducting portion 912 and the conductor 941 are separately manufactured and then are connected to each other, a loss of conduction may occur due to a seam 950. Thus, in some implementations, the second signal conducting portion 912 and the conductor 941 may be connected to each other without using a separate seam, (i.e., seamlessly connected to each other). Accordingly, it is possible to decrease a conductor loss caused by the seam 950. For instance, the second signal conducting portion 912 and a ground conducting portion 913 may be seamlessly and integrally manufactured. Similarly, the first signal conducting portion 911, the conductor 942 and the ground conducting portion 913 may be seamlessly and integrally manufactured.

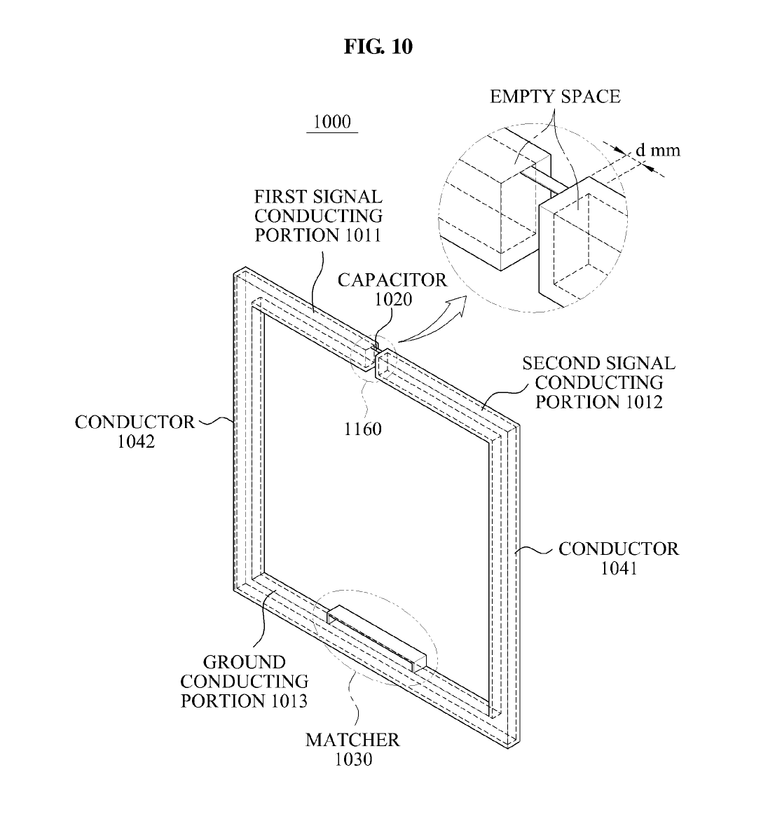

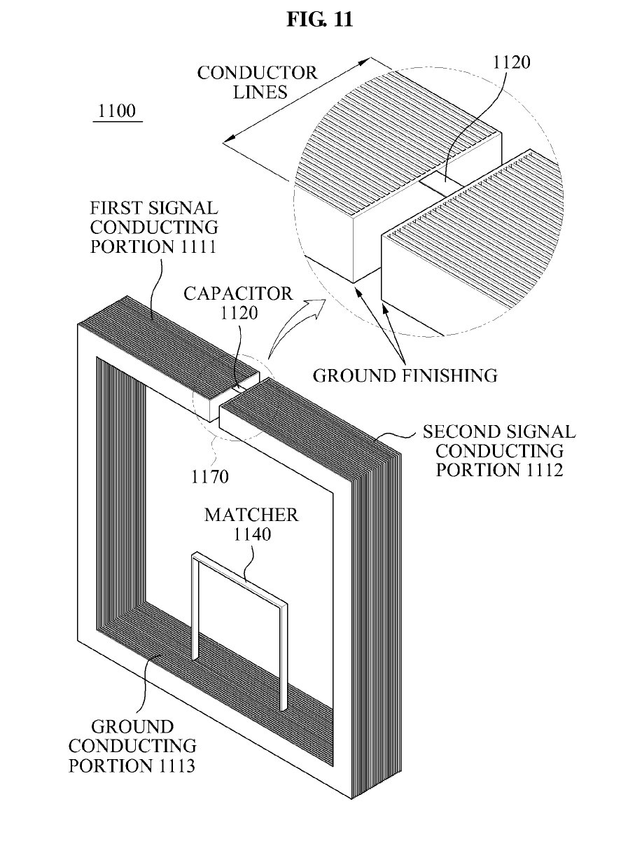

A matcher 930 may be provided that is similarly constructed as described herein in one or more embodiments. FIG. 10 illustrates a resonator 1000 for a wireless power transmission, configured as a hollow type.

Referring to FIG. 10, each of a first signal conducting portion 1011, a second signal conducting portion 1012, a ground conducting portion 1013, and conductors 1041 and 1042 of the resonator 1000 configured as the hollow type structure. As used herein the term “hollow type” refers to a configuration that may include an empty space inside.

For a given resonance frequency, an active current may be modeled to flow in only a portion of the first signal conducting portion 1011 instead of all of the first signal conducting portion 1011, the second signal conducting portion 1012 instead of all of the second signal conducting portion 1012, the ground conducting portion 1013 instead of all of the ground conducting portion 1013, and the conductors 1041 and 1042 instead of all of the conductors 1041 and 1042. When a depth of each of the first signal conducting portion 1011, the second signal conducting portion 1012, the ground conducting portion 1013, and the conductors 1041 and 1042 is significantly deeper than a corresponding skin depth in the given resonance frequency, it may be ineffective. The significantly deeper depth may, however, increase a weight or manufacturing costs of the resonator 1000 in some instances.

Accordingly, for the given resonance frequency, the depth of each of the first signal conducting portion 1011, the second signal conducting portion 1012, the ground conducting portion 1013, and the conductors 1041 and 1042 may be appropriately determined based on the corresponding skin depth of each of the first signal conducting portion 1011, the second signal conducting portion 1012, the ground conducting portion 1013, and the conductors 1041 and 1042. When each of the first signal conducting portion 1011, the second signal conducting portion 1012, the ground conducting portion 1013, and the conductors 1041 and 1042 has an appropriate depth deeper than a corresponding skin depth, the resonator 1000 may become light, and manufacturing costs of the resonator 1000 may also decrease.

For example, as shown in FIG. 10, the depth of the second signal conducting portion 1012 (as further illustrated in the enlarged view region 1060 indicated by a circle) may be determined as “d” mm and d may be determined according to

$$d = \frac{1}{\sqrt{π f μ σ}} .$$

Here, f denotes a frequency, μ denotes a magnetic permeability, and σ denotes a conductor constant. In one implementation, when the first signal conducting portion 1011, the second signal conducting portion 1012, the ground conducting portion 1013, and the conductors 1041 and 1042 are made of a copper and they may have a conductivity of 5.8×10⁷ siemens per meter (S·m⁻¹), the skin depth may be about 0.6 mm with respect to 10 kHz of the resonance frequency and the skin depth may be about 0.006 mm with respect to 100 MHz of the resonance frequency.

A capacitor 1020 and a matcher 1030 may be provided that are similarly constructed as described herein in one or more embodiments.

FIG. 11 illustrates a resonator 1100 for a wireless power transmission using a parallel-sheet.

Referring to FIG. 11, the parallel-sheet may be applicable to each of a first signal conducting portion 1111 and a second signal conducting portion 1112 included in the resonator 1100.

Each of the first signal conducting portion 1111 and the second signal conducting portion 1112 may not be a perfect conductor and thus, may have an inherent resistance. Due to this resistance, an ohmic loss may occur. The ohmic loss may decrease a Q-factor and also decrease a coupling effect.

By applying the parallel-sheet to each of the first signal conducting portion 1111 and the second signal conducting portion 1112, it may be possible to decrease the ohmic loss, and to increase the Q-factor and the coupling effect. Referring to the enlarged view portion 1170 indicated by a circle, when the parallel-sheet is applied, each of the first signal conducting portion 1111 and the second signal conducting portion 1112 may include a plurality of conductor lines. The plurality of conductor lines may be disposed in parallel, and may be electrically connected (i.e., shorted) at an end portion of each of the first signal conducting portion 1111 and the second signal conducting portion 1112.

When the parallel-sheet is applied to each of the first signal conducting portion 1111 and the second signal conducting portion 1112, the plurality of conductor lines may be disposed in parallel. Accordingly, a sum of resistances having the conductor lines may decrease. Consequently, the resistance loss may decrease, and the Q-factor and the coupling effect may increase.

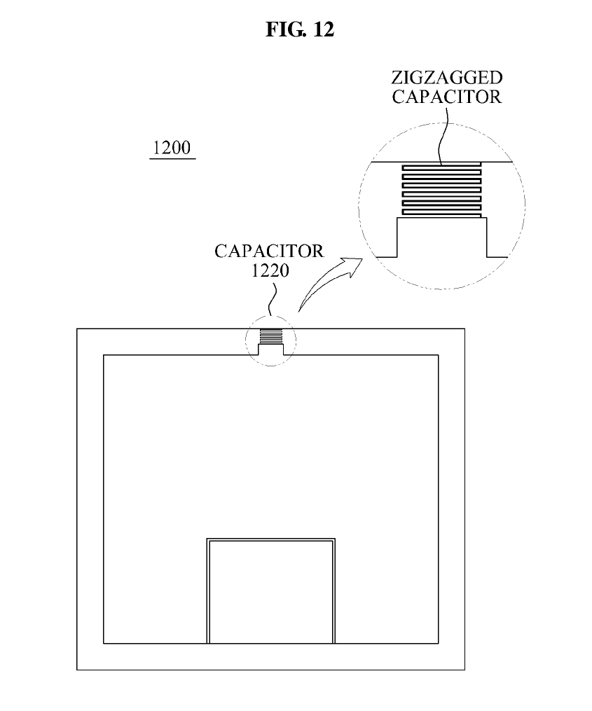

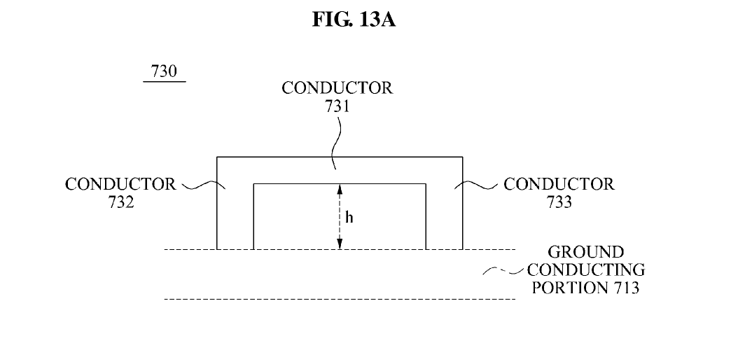

A capacitor 1120 and a matcher 1130 positioned on the ground conducting portion 1113 may be provided that are similarly constructed as described herein in one or more embodiments. FIG. 12 illustrates a resonator 1200 for a wireless power transmission, including a distributed capacitor.

Referring to FIG. 12, a capacitor 1220 included in the resonator 1200 is configured for the wireless power transmission. A capacitor used as a lumped element may have a relatively high equivalent series resistance (ESR). A variety of schemes have been proposed to decrease the ESR contained in the capacitor of the lumped element. According to an embodiment, by using the capacitor 1220 as a distributed element, it may be possible to decrease the ESR. As will be appreciated, a loss caused by the ESR may decrease a Q-factor and a coupling effect.

As shown in FIG. 12, the capacitor 1220 may be configured as a conductive line having the zigzagged structure.

By employing the capacitor 1220 as the distributed element, it may be possible to decrease the loss occurring due to the ESR in some instances. In addition, by disposing a plurality of capacitors as lumped elements, it is possible to decrease the loss occurring due to the ESR. Since a resistance of each of the capacitors as the lumped elements decreases through a parallel connection, active resistances of parallel-connected capacitors as the lumped elements may also decrease whereby the loss occurring due to the ESR may decrease. For example, by employing ten capacitors of 1 pF each instead of using a single capacitor of 10 pF, it may be possible to decrease the loss occurring due to the ESR in some instances.

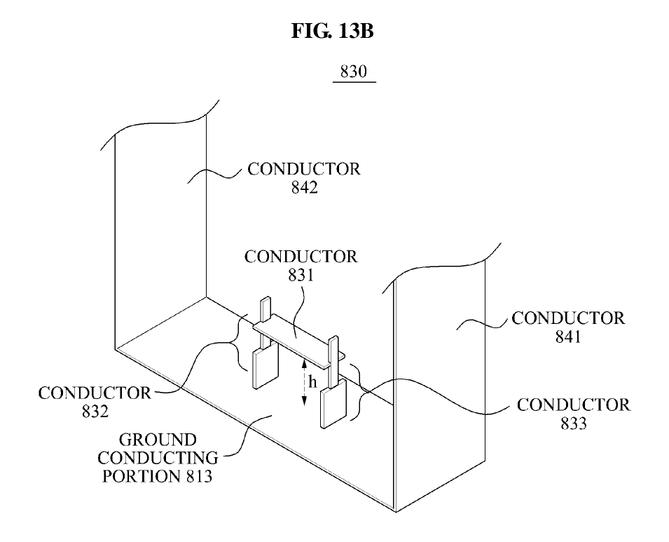

FIG. 13A illustrates one embodiment of the matcher 730 used in the resonator 700 provided in the 2D structure of FIG. 7, and FIG. 13B illustrates an example of the matcher 830 used in the resonator 800 provided in the 3D structure of FIG. 8.

FIG. 13A illustrates a portion of the 2D resonator including the matcher 730, and FIG. 13B illustrates a portion of the 3D resonator of FIG. 8 including the matcher 830.

Referring to FIG. 13A, the matcher 730 may include the conductor 731, a conductor 732, and a conductor 733. The conductors 732 and 733 may be connected to the ground conducting portion 713 and the conductor 731. The impedance of the 2D resonator may be determined based on a distance h between the conductor 731 and the ground conducting portion 713. The distance h between the conductor 731 and the ground conducting portion 713 may be controlled by the controller. The distance h between the conductor 731 and the ground conducting portion 713 can be adjusted using a variety of schemes. For example, the variety of schemes may include, for instance, one or more of the following: a scheme of adjusting the distance h by adaptively activating one of the conductors 731, 732, and 733, a scheme of adjusting the physical location of the conductor 731 up and down, and/or the like.

Referring to FIG. 13B, the matcher 830 may include the conductor 831, a conductor 832, a conductor 833 and conductors 841 and 842. The conductors 832 and 833 may be connected to the ground conducting portion 813 and the conductor 831. Also, the conductors 841 and 842 may be connected to the ground conducting portion 813. The impedance of the 3D resonator may be determined based on a distance h between the conductor 831 and the ground conducting portion 813. The distance h between the conductor 831 and the ground conducting portion 813 may be controlled by the controller, for example. Similar to the matcher 730 included in the 2D structured resonator, in the matcher 830 included in the 3D structured resonator, the distance h between the conductor 831 and the ground conducting portion 813 may be adjusted using a variety of schemes. For example, the variety of schemes may include, for instance, one or more of the following: a scheme of adjusting the distance h by adaptively activating one of the conductors 831, 832, and 833, a scheme of adjusting the physical location of the conductor 831 up and down, or the like.

In some implementations, the matcher may include an active element. Thus, a scheme of adjusting an impedance of a resonator using the active element may be similar as described above. For example, the impedance of the resonator may be adjusted by changing a path of a current flowing through the matcher using the active element.

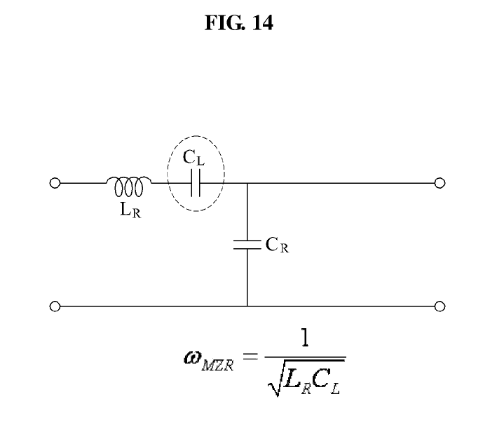

FIG. 14 illustrates one equivalent circuit of the resonator 700 for the wireless power transmission of FIG. 7.

The resonator 700 of FIG. 7 for the wireless power transmission may be modeled to the equivalent circuit of FIG. 14. In the equivalent circuit depicted in FIG. 14, L_{R} denotes an inductance of the power transmission line, C_{L} denotes the capacitor 720 that is inserted in a form of a lumped element in the middle of the power transmission line, and C_{R} denotes a capacitance between the power transmissions and/or ground of FIG. 7.

In some instances, the resonator 700 may have a zeroth resonance characteristic. For example, when a propagation constant is “0”, the resonator 700 may be assumed to have ω_{MZR} as a resonance frequency. The resonance frequency ω_{MZR} may be expressed by Equation 2.

$${ω}_{MZR} = \frac{1}{\sqrt{{L}_{R} {C}_{L}}} \qquad [ Equation 2 ]$$

In Equation 2, MZR denotes a Mu zero resonator.

Referring to Equation 2, the resonance frequency ω_{MZR} of the resonator 700 may be determined by

$$\frac{{L}_{R}}{{C}_{L}} .$$

A physical size of the resonator 700 and the resonance frequency ω_{MZR} may be independent with respect to each other. Since the physical sizes are independent with respect to each other, the physical size of the resonator 700 may be sufficiently reduced.

According to one or more embodiments, there may be provided a DC/DC converter that may detect an amount of current of a DC/DC converter without directly sensing the amount of current of the DC/DC converter, and may control a turn-on period of a turn-on switch based on detected amount of current. When the amount of current is low, the DC/DC converter may decrease the turn-on period to reduce a switching loss.

One or more of the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa. In addition, a non-transitory computer-readable storage medium may be distributed among computer systems connected through a network and non-transitory computer-readable codes or program instructions may be stored and executed in a decentralized manner.

A number of example embodiments have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A direct current-direct current (DC/DC) converter for use in a wireless power receiver, the DC/DC converter comprising:
a voltage converting unit configured to convert, DC voltage, to a predetermined DC voltage;
a turn-on switch configured to control current flow of the DC voltage through the voltage converting unit; and
a switching controller configured to:
detect an amount of current of the voltage converting unit based on a first turn-on period of the turn-on switch,
set a second turn-on period of the turn-on switch based on the detected amount of current, and
control the turn-on switch based on the second turn-on period.

2. The DC/DC converter of claim 1, wherein the amount of current of the voltage converting unit comprises an amount of current inputted to the voltage converting unit or an amount of current outputted from the voltage converting unit.

3. The DC/DC converter of claim 1, wherein, when the detected amount of current is greater than a predetermined reference value, the switching controller is configured to set the second turn-on period to be shorter when the detected amount of current is less than or equal to the predetermined reference value.

4. The DC/DC converter of claim 1, wherein, when the detected amount of current is less than a predetermined reference value, the switching controller is configured to set the second turn-on period to be longer when the detected amount of current is greater than or equal to the predetermined reference.

5. The DC/DC converter of claim 1, wherein the switching controller comprises:
a voltage divider configured to divide, in a predetermined ratio, a voltage outputted from the voltage converting unit;
an error amplifier configured to amplify and output a difference value between an output voltage of the voltage divider and a predetermined reference voltage;
a first comparator configured to compare the output of the error amplifier with a ramp signal, to output a pulse width modulator (PWM) signal to be used for switching the turn-on switch;
a controller configured to set the second turn-on period based on the PWM signal, and to control the turn-on switch based on the second turn-on period;
a current detecting unit configured to detect the amount of current of the voltage converting unit based on the first turn-on period of the turn-on switch, and to generate a frequency control signal that controls a frequency of the ramp signal based on the detected amount of current; and
a generator configured to control the frequency of the ramp signal based on the frequency control signal, and to output the ramp signal having a changed frequency to the first comparator.

6. The DC/DC converter of claim 5, wherein the current detecting unit comprises:
an electric charge pump configured to output electric charges during a turn-on time where the turn-on switch is turned on based on a turn-on period;
a capacitor configured to be charged with electric charges outputted from the electric charge pump during the turn-on time based on the turn-on period, and to discharge electric charges during a turn-off time based on the turn-on period, to output a current measurement voltage;
a second comparator configured to compare a current measurement reference voltage with the current measurement voltage; and
a controller configured to output a frequency control signal that increases the frequency of the ramp signal when the comparison of the second comparator indicates that the current measurement voltage is greater than the current measurement reference voltage, and to output a frequency control signal that decreases the frequency of the ramp signal when the comparison of the second comparator indicates that the current measurement voltage is less than the current measurement reference voltage.

7. The DC/DC converter of claim 6, wherein:
the second comparator comprises a hysteresis comparator that is configured to compare the current measurement voltage with a high-reference voltage or with a low-reference voltage; and
the frequency controller is configured to output a frequency control signal that increases the frequency of the ramp signal when the current measurement voltage is greater than the high-reference voltage, and to output a frequency control signal that decreases the frequency of the ramp signal when the current measurement voltage is less than the low-reference voltage.

8. A wireless power receiver comprising:
a target resonator configured to receive electromagnetic energy from a source resonator;
a rectifier configured to rectify an alternating current (AC) signal received from the target resonator, to generate a direct current (DC) signal; and
a DC/DC converter configured to adjust a signal level of the DC signal, to output a rated voltage, the DC/DC converter comprises:
a voltage converting unit configured to convert, DC voltage, to a predetermined DC voltage;
a turn-on switch configured to control current flow of the DC voltage through the voltage converting unit; and
a switching controller configured to:
detect an amount of current of the voltage converting unit based on a first turn-on period of the turn-on switch,
set a second turn-on period of the turn-on switch based on the detected amount of current, and
control the turn-on switch based on the second turn-on period.

9. The wireless power receiver of claim 8, wherein the amount of current of the voltage converting unit comprises an amount of current inputted to the voltage converting unit or an amount of current outputted from the voltage converting unit.

10. The wireless power receiver of claim 8, wherein, when the detected amount of current is greater than a predetermined reference value, the switching controller sets the second turn-on period to be shorter when the detected amount of current is less than or equal to the predetermined reference value.

11. The wireless power receiver of claim 8, wherein, when the detected amount of current is less than a predetermined reference value, the switching controller sets the second turn-on period to be longer when the amount of current is greater than or equal to the predetermined reference value.

12. The wireless power receiver of claim 8, wherein the switching controller comprises:
a voltage divider configured to divide, in a predetermined ratio, a voltage outputted from the voltage converting unit;
an error amplifier configured to amplify and output a difference value between an output voltage of the voltage divider and a predetermined reference voltage;
a first comparator configured to compare the output of the error amplifier with a ramp signal, to output a pulse width modulator (PWM) signal to be used for switching the turn-on switch;
a controller configured to set the second turn-on period based on the PWM signal, and to control the turn-on switch based on the second turn-on period;
a current detecting unit configured to detect the amount of current of the voltage converting unit based on the first turn-on period of the turn-on switch, and to generate a frequency control signal that controls a frequency of the ramp signal based on the detected amount of current; and
a generator configured to control the frequency of the ramp signal based on the frequency control signal, and to output the ramp signal having a changed frequency to the first comparator.

13. The wireless power receiver of claim 12, wherein the current detecting unit comprises:
an electric charge pump configured to output electric charges during a turn-on time where the turn-on switch is turned on based on a turn-on period;
a capacitor configured to be charged with electric charges outputted from the electric charge pump during the turn-on time based on the turn-on period, and to discharge electric charges during a turn-off time based on the turn-on period, to output a current measurement voltage;
a second comparator configured to compare a current measurement reference voltage with the current measurement voltage; and
a frequency controller configured to output a frequency control signal that increases the frequency of the ramp signal when the comparison of the second comparator indicates that the current measurement voltage is greater than the reference voltage, and to output a frequency control signal that decreases the frequency of the ramp signal when the comparison of the second comparator indicates that the current measurement voltage is less than the current measurement reference voltage.

14. The wireless power receiver of claim 13, wherein:
the second comparator comprises a hysteresis comparator that compares the current measurement voltage with a high-reference voltage or with a low-reference voltage; and
the frequency controller outputs a frequency control signal that increases the frequency of the ramp signal when the current measurement voltage is greater than the high-reference voltage, and outputs a frequency control signal that decreases the frequency of the ramp signal when the current measurement voltage is less than the low-reference voltage.

15. A method for converting direct current to direct current (DC/DC) comprising:
converting, DC voltage, to a predetermined DC voltage;
controlling current flow of the DC voltage via a turn-on switch;
detecting an amount of current based on a first turn-on period on the turn-on switch; and
setting a second turn-on period of the turn-on switch based on the detected amount of current.

16. The method of claim 15, wherein, when the detected amount of current is greater than a predetermined reference value, the second turn-on period is set to be shorter when the detected amount of current is less than or equal to the predetermined reference value.

17. The method of claim 15, wherein, when the detected amount of current is less than a predetermined reference value, the second turn-on period is set to be longer when the detected amount of current is greater than or equal to the predetermined reference.
